(19) United States
(12) Patent Application Publication
(10) Pub. No.: US 2010/0315958 A1
(43) Pub. Date: Dec. 16, 2010

(54) METHOD FOR NON-COOPERATIVE MEASUREMENT OF NETWORK DATA-PATH QUALITY

(76) Inventors: Xiapu LUO, Jiangmen City (CN); Edmand Wun-Wah Chan, Hong Kong (CN); Rocky Kow-Chuen Chang, Hong Kong (CN)

Correspondence Address: WILKINSON & GRIST, 6TH FLOOR, PRINCE''S BUILDING, CHATER ROAD, CENTRAL, HONG KONG, HK

(21) Appl. No.: 12/482,470

(22) Filed: Jun. 11, 2009

(51) Int. Cl. H04L 12/26

(52) U.S. Cl. 370/248

(57) ABSTRACT

A method and apparatus for measuring network path quality in a non-cooperative manner, which involves sending a probe consisting of a plurality of probe data packets to a remote node and receiving a response consisting of at least one response data packet therefrom. Both the probe and response data packets carry application messages and are exchanged according to normal transmission mechanisms, so that the method can void the reliability problem suffered by methods using non-data probes. The response data packets, at the same time, provide sufficient information for obtaining a rich set of data-path quality metrics in an efficient way.

### FILED OF THE INVENTION

The present invention relates to a method of measurement of network path quality in communications networks. Particularly, it relates to a method and apparatus for measuring data-path quality from a single endpoint of the path.

### BACKGROUND OF THE INVENTION

The ability of measuring the end-to-end path quality of a communications network, particularly the Internet, is critically important for data centers, Internet service providers, Internet-based businesses, scientific studies of the Internet behavior, and many other purposes. The path quality can be measured by packet losses, packet reordering (packets are received in a different order from their transmission order), delay and other types of path metrics. The methods of measuring these path metrics are broadly classified into active measurement and passive measurement. The active measurement method involves transmissions of additional packets between the two endpoints of a network path designed solely for path measurement purposes. On the other hand, the passive measurement method does not send any additional packets, and it analyzes the captured network traffic.

Many active measurement methods require a cooperation of both endpoints of a network path where special programs or devices need be installed at both endpoints. By controlling both endpoints, they can generally measure many path metrics, and control and calibrate the measurement accuracy. However, as a serious downside, the cooperation requirement severely limits their usage and scope of applications, because a network path generally spans across multiple autonomous networks. Therefore, it is very difficult, if not impossible, to install the required software or devices for various applications and circumstances. Non-cooperative measurement methods, on the other hand, do not suffer from this restriction; they allow a single endpoint (or a measuring node) to conduct measurement for a large number of network paths. Without controlling the other endpoint, the measuring node sends probe packets to elicit response packets from the remote endpoint (or node) for path measurement.

Although non-cooperative methods have been researched and developed for many years, they still suffer from at least two main problems at the present time. The first main problem is that most existing methods do not provide a reliable measurement for a number of reasons. First of all, the probe packets (or its sending rate) may be considered anomalous and therefore filtered by firewalls, intrusion detection systems and other security devices on the path. As a result, no response packets will be returned to the measuring node. Second, the probe packets can successfully elicit response packets, but they fail to contain the required information for path measurement. Third, the probe packets can successfully elicit the response packets that contain the required information for path measurement, but the measurement results may not reflect the actual path quality experienced by normal data packets (i.e., data-path quality).

For the first unreliability problem, it is well known that routers and end systems nowadays do not always respond to (a “high” rate of) ICMP packets from ICMP Ping and other measurement methods relying on ICMP packets, because ICMP has been exploited in different network attacks. The same can also be said for measurement methods using TCP SYN packets, TCP RST packets and sending UDP packets to a closed port. Moreover, sting proposed in S. Savage, “Sting: a TCP-based Network Measurement Tool,” Proc. USENIX Symp. Internet Technologies and Systems 1999, measures forward-path (or forwarding) and reverse-path (or returning) packet loss statistics by sending an anomalous burst of out-of-ordered probe TCP data packets with zero advertised window size. This highly unusual packet pattern is also susceptible to packet filtering. As another example, POINTER proposed in X. Luo and R. Chang, “Novel Approaches to End-to-End Packet Reordering Measurement,” Proc. ACM/USENIX IMC 2005, measures forward-path and reverse-path packet reordering statistics by sending probe TCP data packets with unacceptable TCP sequence and acknowledgment numbers.

For the second unreliability problem, tulip proposed in R. Mahajan, N. Spring, D. Wetherall and T. Anderson, “User-Level Internet Path Diagnosis,” Proc. ACM SOSP 2003, uses probe UDP data packets and ICMP packets to localize packet loss and packet reordering events on a network path. Moreover, both loss and reordering measurement are based on the assumption that the routers on the paths and the remote nodes support a consecutive increment of the Internet Protocol's (IP's) identification field. This assumption, however, is no longer true for many end systems and routers at the present time.

The third unreliability problem relates to measurement methods using non-data probes. A non-data probe or response (packet) is a packet not designated for transporting application messages, such as the ICMP, TCP SYN and TCP RST packets, and pure TCP acknowledgement packets (TCP ACKs). These non-data probe and response packets do not necessarily measure the data-path quality, because data packets and non-data packets may be processed differently inside routers and end systems. The discrepancy between the two could be very significant. Besides the ICMP Ping and tulip measurement, sting, POINTER and TCP Sidecar proposed in R. Sherwood and N. Spring, “Touring the Internet in a TCP Sidecar,” Proc. ACM/USENIX IMC 2006, also suffer from this problem, because all of them elicit TCP ACKs for the reverse-path measurement.

The methods above suffer from the reliability problems, because they conduct data-path quality measurement through a non-data channel (a separate control protocol or control packets in a data transport protocol) or exceptional protocol behavior. The result of this design choice is that these probe and response packets can be easily tampered by intermediary nodes on the path either for good purposes (guarding against attacks) or not so good purposes (e.g., manipulating the measurement results).

The second major problem of the existing methods is that they provide a very limited set of path quality metrics. As various applications demand different quality of experience from the underlying network paths, it is necessary to measure the path quality using as many metrics as possible. The limited set of quality metrics is a result of three specific limitations. First of all, many non-cooperative methods, such as Ping and its variants, can measure the metrics of a round-trip as a whole but cannot measure separately, for example, packet losses happened in the forward path (i.e., from the measuring node to the remote node) and in the reverse path (i.e., from the remote node to the measuring node). Since network paths are generally asymmetric and many applications are asymmetric in their traffic volume, the impacts of the forward-path quality and reverse-path quality on the application performance are not the same.

The second limitation is that the existing methods generally can measure only one or two types of quality metrics. For example, Ping measures round-trip delay and round-trip packet loss, Sideping (a tool based on the TCP Sidecar framework) measures round-trip delay, sting measures forward-path and reverse-path packet loss statistics, and POINTER measures forward-path and reverse-path packet reordering statistics. Although tulip can measure packet loss, packet reordering and queueing delay, it suffers from the reliability problems mentioned above, uses different probes for loss and reordering measurement, and cannot measure all packet loss scenarios. Although it is possible to use multiple tools to obtain a richer set of quality metrics, this approach, in practice, is ineffective, difficult to coordinate and prone to measurement and configuration errors.

The third limitation is that the existing methods cannot measure path metrics for different response packet sizes. Although sting can measure one-way packet loss, it can measure the reverse-path packet loss only for TCP ACKs which are small, fixed-sized packets. A similar limitation also applies to POINTER which elicits TCP ACKs to measure reverse-path packet reordering. It is well known that a large packet size is more prone to packet loss, and a small packet size is more prone to packet reordering. Without controlling the response packet size, the existing methods can measure the path metrics only for a particular given packet size.

Measuring multiple metrics using the same probe is a difficult problem, because the probe packets must elicit sufficient information in the returned response packets for path quality measurement. Using ICMP cannot achieve this goal, because the response packets contain very limited information. Using TCP SYN, TCP RST and TCP ACK cannot achieve this goal either, because a single packet of this kind cannot measure multiple metrics, and their sizes cannot be controlled by the measuring node.

As a result, the need remains for a non-cooperative method for data-path quality measurement, which uses a number of quality metrics and ensures sufficient measurement accuracy and reliability.

### SUMMERY OF THE INVENTION

The present invention provides a new method and a new apparatus for measuring data-path quality with multiple path metrics from a single endpoint of the path (which is called a measuring node). A probe consisting of a plurality of probe data packets is sent to elicit at least one response data packet from the remote endpoint (or node) of the path for the measurement. To practice the present invention, the probe data packets of a probe must be sent back to back without a delay or with a delay that will not cause packet retransmissions from the remote node. Moreover, the size of the probe data packets can be configured by the measuring node.

The probe and response data packets carry application messages. The set of possible sequences of the response data packets is predetermined and provides sufficient information for determining each probe packet's delivery status and each new response data packet's delivery status. The probe data packets could be received in the same order, or a different order, from their transmission order. Moreover, each probe data packet could be received or lost on the forward path; each response data packet could be received or lost on the reverse path. If a plurality of response data packets is received, their receiving order could be the same as, or different from, their transmission order. The packet delivery statuses are used for computing forward-path and reverse-path packet loss statistics, forward-path and reverse-path packet reordering statistics, and per-packet round-trip time (RTT).

As the first important aspect of the present invention, the probe data packets cannot be distinguished from normal application data packets based on their header values. Moreover, the probe data packets are designed to elicit response data packets according to the normal data transmission mechanisms. As a result of the above, both the probe and response data packets are regarded as normal data traffic. Another benefit is that the probe and response data packets are processed the same way as for normal application data packets traveling on the same path. Therefore, the measurement results more accurately reflect the path quality experienced by normal application data packets.

As the second important aspect of the present invention, a probe data packet carries at least one application message which is designed to elicit at least one application message from the remote node for the data-path quality measurement. Therefore, a response data packet carries at least one application message or a portion of an application message. For the purpose of this invention, an “application message” is any message permitted in an application-layer protocol session. In other words, the application messages sent through the probe and response data packets are exchanged according to a normal application-layer protocol. As a result, the application messages are regarded as normal application traffic.

As the third important aspect of the present invention, each response data packet is designed to contain a sequence number and an acknowledgement number (for the data reliability service). The sequence of the response data packets, which are identified by their sequence and acknowledgement numbers, is distinguishable for each probe packets' delivery scenario (such as, the probe packets received with the same order and the loss of the first probe packet) on the forward path. Moreover, these sequences can be predetermined by the measuring node after sending the probe packets. Thus, the response data packets contain sufficient information for determining the delivery status of each probe data packet and of each response data packet. Furthermore, a reliable data transport protocol may provide a mechanism for a measuring node to control the size of the response data packets.

As a particular embodiment of the present invention, Transmission Control Protocol (TCP) data packets are used for data-path quality measurement to illustrate the present invention in this application, although the data packets of other type, such as the Stream Control Transfer Protocol, may also be used and, in view of the teaching of the present disclosure, practicing the present invention with other data packets is within ordinary skill in the art. In an embodiment using TCP data packets, two probe TCP data packets are sent to elicit at most two new response TCP data packets for the data-path quality measurement. Each probe TCP data packet carries a Hypertext Transfer Protocol (HTTP) GET message that elicits an HTTP response message sent in one or more response TCP data packets.

As seen from the above, the present invention avoids the two major problems suffered by the existing non-cooperative measurement methods. The present invention provides reliable measurement because of conducting the measurement using normal data packet exchanges and normal application message exchanges. Moreover, the response data packets contain sufficient information for obtaining at least three types of data-path quality metrics. The packet loss and reordering metrics are obtained for the forward path and reverse path, and for different combinations of the probe and response data packet sizes.

The various features of novelty which characterize the invention are pointed out with particularity in the claims annexed to and forming a part of this disclosure. For a better understanding of the invention, its operating advantages and specific objects attained by its use, reference should be made to the drawings and the following description in which there are illustrated and described preferred embodiments of the invention.

### BRIEF DESCRIPTION OF THE DRAWINGS

The objects, features and advantages of the present invention will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 is a block diagram illustrating a particular embodiment of the present invention.

FIG. 2 is a flow diagram illustrating successive probe rounds in a particular embodiment according to the present invention.

FIG. 3 is a block diagram illustrating an exemplary measuring node according to the present invention.

FIG. 4 is a time-line diagram illustrating an exemplary measurement session executed by a measuring node for web service according to the present invention.

FIG. 5 is a time-line diagram illustrating the server's responses in two successive probe rounds in a particular embodiment according to the present invention.

FIG. 6 is a time-line diagram illustrating the server's responses to receiving a reordered probe in a particular embodiment according to the present invention.

FIG. 7 is a time-line diagram illustrating the server's responses to receiving only the second probe data packet in a particular embodiment according to the present invention.

FIG. 8 is a time-line diagram illustrating the server's responses to receiving only the first probe data packet in a particular embodiment according to the present invention.

FIG. 9 is a time-line diagram illustrating the server's responses to receiving no probe data packets in a particular embodiment according to the present invention.

FIG. 10 is a time-line diagram illustrating the server's responses, including a TCP ACK, to receiving a reordered probe in a particular embodiment according to the present invention.

FIG. 11 is a block diagram illustrating a partial set of path metrics supported in a particular embodiment according to the present invention.

### DETAILED DESCRIPTION OF PARTICULAR EMBODIMENTS OF THE INVENTION

An Overview

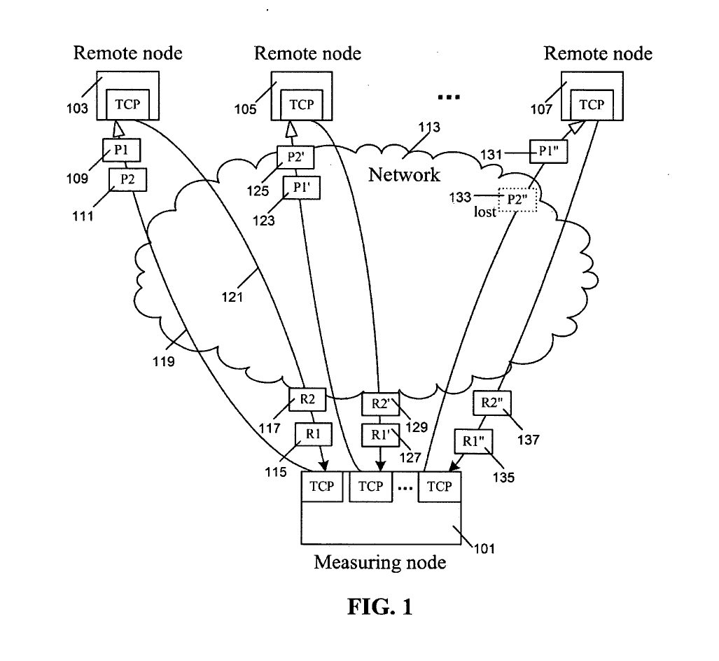

FIG. 1 is a block diagram illustrating a particular embodiment in accordance with the present invention. It comprises a measuring node 101 and remote nodes 103, 105 and 107. The measuring node 101 sends two probe TCP data packets P1 109 and P2 111 to the remote node 103 through a network 113 which usually includes multiple hops (such as, routers). The remote node 103, in response to receiving 109 and 111, sends two response TCP data packets R1 115 and R2 117 to 101. The data packets 109, 111, 115 and 117 are sent in the same TCP connection established between 101 and 103. The probe TCP data packets are sent on a forward path 119, whereas the response TCP data packets are sent on a reverse path 121.

The measuring node 101 may, at the same time, send two probe data packets P1′ 123 and P2′ 125 to the remote node 105 in another TCP connection established between 101 and 105. However, P1′ 123 and P2′ 125 are received by 105 in a reverse order. The two reordered packets elicit from 105 two response data packets R1′ 127 and R2′ 129.

The measuring node 101 may, at the same time, send two probe data packets P1″ 131 and P2″ 133 to the remote node 107 in another TCP connection established between 101 and 107. However, P2″ 133 is lost in the network 113. P1″ 131 elicits from 107 two response TCP data packets R1″ 135 and R2″ 137.

The response TCP data packets and their arrival order provide enough information for 101 to determine whether P1 109 is received by 103 or lost on 119, whether P2 111 is received by 103 or lost on 119. If both 109 and 111 are received by 103, 101 can determine whether they are received in the same order or in a reverse order. At the same time, 101 can determine whether R1 115 is lost or R2 117 is lost on 121. If both 115 and 117 are received, 101 can determine whether they are received in the same order as the transmission order or not. Moreover, the round-trip time (RTT) for each probe TCP data packet can be computed if the probe TCP data packet and the response TCP data packet elicited by the probe packet are not lost.

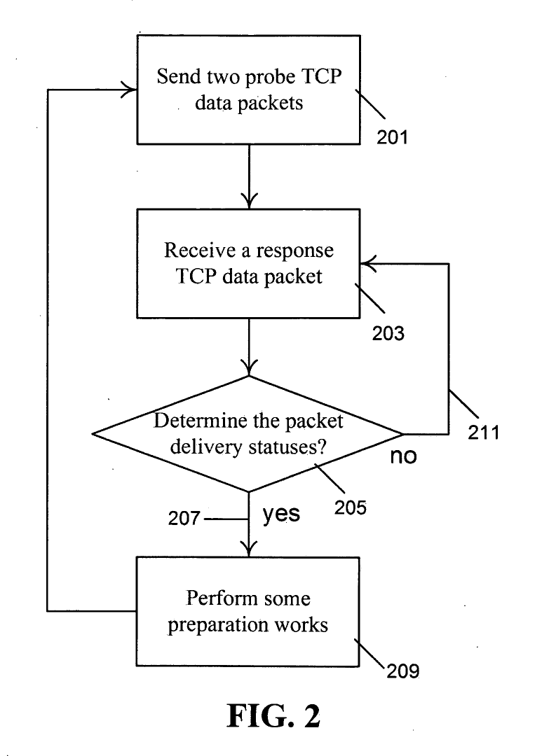

FIG. 2 is a flow diagram illustrating successive probe rounds in accordance with the present invention. After sending two probe TCP data packets 201, the measuring node is in a receiving mode for response TCP data packets elicited from the remote node. After receiving a response TCP data packet 203, the response TCP data packets received so far after sending the probe packets 201 will be used to determine the delivery statuses of each probe TCP data packet and of each response TCP data packet 205. If such a determination can be made 207, some preparation works may be performed 209 before sending two new probe TCP data packets 201. If such a determination cannot be made 211, the measuring node will wait for the next response TCP data packet 203.

After collecting the packet delivery statuses and the RTTs for a successive number of probe rounds, statistics for a number of data-path quality metrics can be computed. For example, an average RTT could be computed for the first probe TCP data packets. At the same time, an average packet loss rate for the first probe TCP data packets can be computed (i.e., forward-path packet loss rate). Similarly, an average packet loss rate for the first response TCP data packets (i.e., reverse-path packet loss rate) can be computed. If both probe TCP data packets are received, an average packet reordering rate can be computed for them (i.e., forward-path packet reordering rate). Similarly, if both response TCP data packets are received, an average packet reordering rate can be computed for them (i.e., reverse-path packet reordering rate).

Measurement in a Web Session

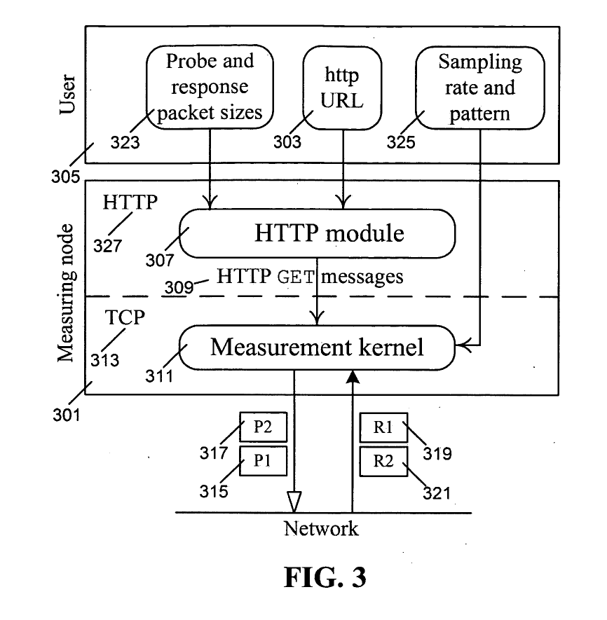

FIG. 3 is a block diagram illustrating in greater detail an exemplary measuring node in accordance with the present invention. The measuring node 301 takes in an http URL 303 from a user 305. With the URL 303, the HTTP module 307 at the HTTP layer 327 prepares an HTTP GET message 309 for the URL 303 and passes it to the measurement kernel 311 at the TCP layer 313. The measurement kernel 311 is responsible for preparing and dispatching the probe TCP data packets P1 315 and P2 317. The probe TCP data packets 315 and 317 carry the HTTP GET messages 309 in their data payloads.

The measurement kernel 311 is also responsible for receiving the response TCP data packets R1 319 and R2 321 that carry an HTTP response message in their data payloads and for determining the packet delivery statuses and computing the per-packet RTTs. Additionally, the user 305 may input the probe and response packet sizes 323, and the sampling rate and pattern 325. The packet size request 323 is passed to the HTTP module 307 for meeting the packet size request. The sampling rate and pattern request 325 is passed to the measurement kernel 311 for meeting the sampling process request.

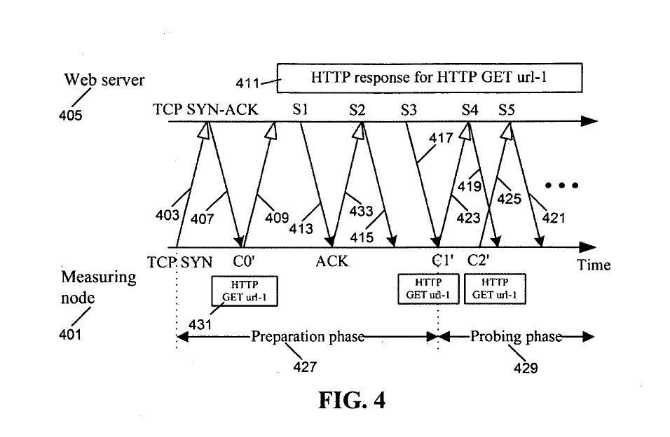

FIG. 4 is a time-line diagram illustrating an exemplary measurement session executed by a measuring node for web service in accordance with the present invention. The measuring node 401 sends a TCP SYN packet 403 to establish a TCP connection with the web server 405. After receiving the TCP SYN-ACK packet 407, the measuring node 401 sends a probe TCP data packet C0′ 409 carrying an HTTP GET message for url-1 431. After receiving the request 431, the web server 405 prepares an HTTP response message for url-1 411 that is sent in a consecutive number of response TCP data packets S1 413, S2 415, S3 417, S4 419, S5 421 and so on.

After receiving S2 415 and S3 417 which are elicited by a TCP ACK 433, the measuring node 401 starts the first probe round by dispatching the first two probe TCP data packets C1′ 423 and C2′ 425 which elicit two response TCP data packets S4 419 and S5 421, respectively, for data-path quality measurement. The two probe TCP data packets C1′ 423 and C2′ 425 may also carry the same HTTP GET message for url-1 431. A new probe round may start after receiving the response TCP data packet S5 421. The measurement conducted in this TCP connection therefore consists of two consecutive phases: preparation 427 and probing 429.

HTTP Module

The HTTP module is specific to using HTTP in the application layer for the path measurement, but the measurement kernel remains the same for any application-specific module. Interfacing between the HTTP module and the measurement kernel is based on the HTTP GET messages passed from the HTTP module to the measurement kernel. The HTTP module can therefore be designed and implemented independent of the measurement kernel. The HTTP module's main tasks include finding one or more qualified http URLs for the user-specified packet sizes and preparing the HTTP GET messages for the qualified http URLs.

An http URL is considered qualified if its HTTP GET message can be retrofitted into a probe data packet with the specified probe packet size, and the HTTP GET message can elicit from the server at least five response data packets with the specified response packet size. A minimum of five response data packets is required because of the three additional data response packets 413, 415 and 417 in the preparation phase 427. Let Zp and Zr be the user-specified probe packet size and response packet size in bytes, respectively. All packet sizes include the IP and TCP headers. Therefore, the length of an HTTP GET message for a qualified URL will not exceed Zp−40 bytes (assuming a 40-byte TCP/IP header). Moreover, the length of the corresponding HTTP response message, including the HTTP response header and message body, must be at least 5×(Zr−40) bytes.

Checking the length of an HTTP GET message is straightforward. However, verifying whether a URL meets the size requirement for the response data packets requires some work. If the Content-Length header field is present in the HTTP response message, the length is just a sum of the field value and the HTTP response header's length. Otherwise, the HTTP module will download the entire HTTP response message to determine its length. If no qualified URL can be obtained, the HTTP module will perform web crawling to retrieve all the available URLs, starting at the root of the web server and down to a certain depth level.

Besides, the HTTP GET message for a qualified URL must induce a 200 (OK) response. The 404 (Not Found) responses should not be used in order not to cause security alerts on the site. Similarly, the HTTP response messages that do not have a message body (e.g., 304 (Not Modified)) should be avoided.

To craft a Zp-byte probe data packet for an HTTP GET message, the HTTP module expands the packet size through the HTTP Referer field. Since some web servers only accept requests referred from their own web pages, the HTTP module first appends the requested URL to the Referer field to avoid possible blocking. If the packet size still falls short, the HTTP module further appends a customized string consisting of a probe ID and possibly other appropriate information (e.g., a contact email address) repeatedly until reaching the user-specified packet size. Moreover, to reduce the delay in dispatching the probes due to possible context switching, the HTTP module will have prepared the HTTP GET messages for the qualified http URLs before starting the measurement.

The HTTP module exploits the HTTP/1.1's request pipelining feature by including an HTTP GET message in each probe data packet for path measurement. These pipelined HTTP GET messages could request for a single or multiple URLs. There are also other alternatives to configuring the probe data packets, such as sending a large HTTP GET message in several consecutive probe data packets or including multiple HTTP GET messages in a single probe data packet. But these alternatives introduce the problems of delaying the return of the response data packets and sending too many HTTP GET messages.

Moreover, an HTTP response message usually will not fully occupy the last response data packet. Therefore, a response data packet may contain a portion of data from two HTTP response messages. On the other hand, it is observed that some response data packets contain only the last chunks of the HTTP response messages. Therefore, these response packets do not meet the packet size requirement. In this case, the HTTP module will use the next HTTP response message to continue the measurement in the same TCP connection.

Another important mechanism is to prevent web servers from compressing the HTTP response messages which, for example, is performed by Apache server's mod_deflate module. The compressed HTTP response messages could affect the measurement, because the expected number of response data packets for a qualified URL may be reduced. Therefore, each HTTP GET message specifies “Accept-Encoding: identity;q=1, *;q=0”, where “identity;q=1” indicates that the “identity” encoding (i.e., no transformation) should be performed on the entity of the response, and “*;q=0” means avoiding other encoding methods.

Besides using qualified URLs for measurement, the range request feature in HTTP/1.1 can be exploited for using unqualified URLs for path measurement. A range request is for requesting multiple overlapped ranges of the same web object from a web server that accepts range requests. The HTTP response message for an unqualified URL can be “expanded” to fulfill the minimum size requirement (i.e., five response data packets) through the range request. For example, if a web server contains only a single web object of 200 bytes, the following range request header can be inserted in each HTTP GET message: “Range: bytes=−200,−200,−200,−200”. Each byte-ranges-specifier “−200” requests the server to return the final 200 bytes of the web object. In response to the range request, the server will return the four range responses in a single HTTP response message of 800 bytes.

Measurement Kernel

The measurement kernel is designed and implemented independent of specific TCP applications. It conducts the measurement in one or more concurrent TCP connections. To support a higher sampling rate and non-periodic sampling patterns, multiple TCP connections are usually required. The POSIX Threads library could be used to manage the individual TCP connections and the entire measurement session. Moreover, since some web servers may limit the number of concurrent TCP connections initiated from an IP address, different source IP addresses may be assigned to the connections.

The number of TCP connections used in a measurement session is a configurable parameter. The measurement kernel establishes and maintains the configured number of TCP connections for a measurement session. It also prepares a probe schedule according to the user-specified sampling pattern (such as periodic and Poisson) and sampling rate before starting the measurement. The probe schedule contains a list of probe tasks, each of which includes a dispatch time and a probe number. The probe tasks are enqueued to a probe-schedule queue as soon as they are generated.

The manner and mechanisms of conducting the measurement are the same for each TCP connection. The measurement in each TCP connection is conducted in two consecutive phases: preparation and probing. The preparation phase is for performing the ground works for the probing phase. In the probing phase, it dispatches the probes containing the HTTP GET messages that have already been prepared by the HTTP module, analyzes the response data packets and terminates the connection when the session ends or encounters exceptions.

In the preparation phase, the measuring node configures the probe and response data packet sizes. The measuring node 401 advertises its maximum segment size (MSS), say MSSc bytes, in the TCP SYN packet 403. The server 405 advertises its MSS, say MSSs bytes, in the TCP SYN-ACK packet 407. The measuring node 401 can then set the probe data packet size to at most MSSs+40 bytes, and the response data packet size to at most min{MSSs, MSSc}+40 bytes. Another purpose of this phase is to ramp up the server's congestion window to two TCP data segments for starting the probing phase 429. If the server's initial congestion window is already at least two TCP data segments (detected by receiving two response data packets after the initial HTTP GET message 431), then the first probe round can be started without sending the TCP ACK 433.

The probing phase starts as soon as receiving two new response TCP data packets 415 and 417 from the server 405. To dispatch a probe, the measurement kernel first retrieves a probe task from the probe-schedule queue. Moreover, any expired probe task, for which its dispatch time has already passed the current time, will be removed from the queue and discarded. When the probe schedule is empty, the measurement kernel closes the TCP connection.

After obtaining a non-expired probe task, the measurement kernel performs a high-resolution sleep (e.g., using clock_nanosleep( ) in time.h) until reaching the dispatch time. Upon waking up, a pair of HTTP GET messages is drawn randomly from the list of the HTTP GET messages already prepared by the HTTP module, and each is sent in a probe data packet.

Linux raw socket could be used to craft and send the probe data packets, and the libpcap 1.0.0 library could be used to capture the probe and response data packets. As a result of bypassing Linux's normal TCP/IP processing, the kernel is unaware of the TCP connections initiated by the measurement kernel and will therefore respond with a TCP RST packet for each response data packet received. A common approach to resolving this problem is to block the RST traffic using Linux's iptables.

Another important issue is to timestamp each probe and response data packet accurately for the RTT measurement. If libpcap is used for capturing the packets, the timestamp from the pcap_pkthdr structure of each probe and response data packet may be used to measure the RTT with a microsecond resolution. Using the user-level timestamp from gettimeofday( ), as another alternative, is less reliable, because its accuracy could be affected by system's context switching.

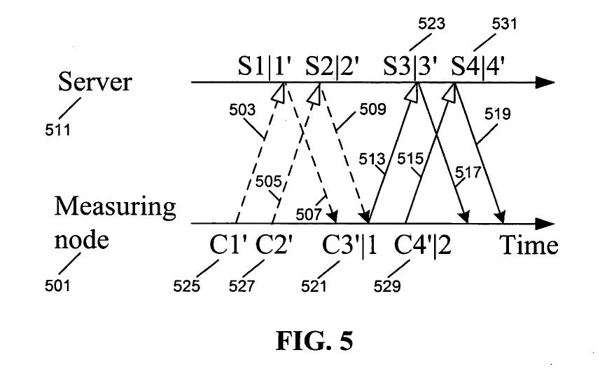

FIG. 5 is a time-line diagram illustrating the server's responses in two successive probe rounds in accordance with the present invention. The measuring node 501 sends two probe data packets 503 and 505 to elicit two response data packets 507 and 509 from the server 511 for the first probe round. After receiving the new response data packets 507 and 509, the measuring node 501 sends two new probe data packets 513 and 515 to elicit two new response data packets 517 and 519 from the server 511 for the second probe round.

A probe data packet is denoted by Cm|n and a response data packet by Sm|n, and m and n are the TCP data packet's sequence number (SN) and acknowledgment number (AN), respectively. Since the probe and response data packets contain MSS-sized TCP data segments, for convenience purpose only, m (=1, 2, . . . ) is used to enumerate the response TCP data segments, and n (=1′, 2′, . . . ) is used to enumerate the response TCP data segments. For example, C3′|1 521 carries the third data segment from the measuring node 501 and an acknowledgment for the first data segment from the server, and S3|3′ 523 carries the third data segment from the server 511 and an acknowledgment for the first three data segments from the measuring node 501. When the AN is not important, just Cm and Sm are used, for example, the first two probe data packets C1′ 525 and C2′ 527.

Each probe data packet acknowledges only one data segment received from the server, although both segments have been received by the time of sending the first probe data packet. For example, C3′|1 521 acknowledges only the server's first data segment, even after receiving both response data packets 507 and 509. Moreover, the probe data packets advertise a receive window of two TCP data segments to constrain the server's send window to two TCP data segments. As a result, each probe data packet, if not reordered, elicits only one new response data packet. For example, C3′|1 521 elicits S3|3′ 523, and C4′|2 529 elicits S4|4′ 531. A new response data packet is a TCP data packet that carries a new data segment from the server.

The RTT is measured based on a probe data packet and its elicited new response data packet (e.g., C3′|1 513 and S3|3′ 517). Therefore, in the absence of packet loss, normally two RTT observations are obtained in a probe round. However, it is more accurate to use the first-probe-packet-RTT for measurement, because the second probe packet's RTT may be biased by the first packet.

There are five possible path events that may happen with the two probe TCP data packets on the forward path: F0: Both probe data packets arrive at the server with the same order; FR: Both probe data packets arrive at the server with a reverse order; F1: The first probe data packet is lost, but the second arrives at the server; F2: The first probe data packet arrives at the server, but the second is lost; and F3: Both probe data packets are lost. There are also five similar events for the two new response data packets on the reverse path: R0, RR, R1, R2 and R3 (by replacing “probe” with “response” and “server” with “measuring node” in F0-F3). As a result,

TABLE 1

| | R0 | RR | R1 | R2 | R3 |
|---|---|---|---|---|---|
| F0 | ✓ | ✓ | ✓ | ✓ | ✓ |
| FR | ✓ | ✓ | ✓ | ✓ | ✓ |
| F1 | ✓ | ✓ | ✓ | ✓ | ✓ |
| F2 | ✓ | — | ✓ | — | — |
| F3 | — | — | — | — | — |

there are 18 possible loss-reordering events, as shown in Table 1: the 17 events indicated by “√” and one event for F3. Others indicated by “-” are not possible, because at most one new response data packet can be elicited (i.e., there is no second response data packet). For F3, no new response data packet can be elicited.

Considering the two probe data packets C3′|1 521 and C4′|2 529, Table 2 summarizes the response data packets elicited for the 18 events based on J. Postel (editor), “Transmission Control Protocol”, RFC 793, IETF, 1981. In addition to the new TCP data segments 3 and 4, the server may retransmit old TCP data segments 1, 2, and 3, and Ŝm|n is used to denote a data retransmission packet. Since the server responses are based on TCP's two basic data transmission mechanisms: acknowledgment-clocked transmissions and timeout-based retransmissions, all operating systems are expected to produce the same responses.

TABLE 2

| | First | Second | Third |
|---|---|---|---|
| Path | Response TCP | Response TCP | Response TCP |
| events | data packets | data packets | data packets |
| 1. F0 × R0 | S3\|3′ | S4\|4′ | — |
| 2. F0 × RR | S4\|4′ | S3\|3′ | — |
| 3. F0 × R1 | S4\|4′ | Ŝ3\|4′ | — |
| 4. F0 × R2 | S3\|3′ | Ŝ3\|4′ | — |
| 5. F0 × R3 | Ŝ3\|4′ | — | — |
| 6. FR × R0 | S3\|2′ | S4\|2′ | Ŝ3\|4′ |
| 7. FR × RR | S4\|2′ | S3\|2′ | Ŝ3\|4′ |
| 8. FR × R1 | S4\|2′ | Ŝ3\|4′ | — |
| 9. FR × R2 | S3\|2′ | Ŝ3\|4′ | — |
| 10. FR × R3 | Ŝ3\|4′ | — | — |
| 11. F1 × R0 | S3\|2′ | S4\|2′ | Ŝ3\|2′ |
| 12. F1 × RR | S4\|2′ | S3\|2′ | Ŝ3\|2′ |
| 13. F1 × R1 | S4\|2′ | Ŝ3\|2′ | — |
| 14. F1 × R2 | S3\|2′ | Ŝ3\|2′ | — |
| 15. F1 × R3 | Ŝ3\|2′ | — | — |
| 16. F2 × R0 | S3\|3′ | Ŝ2\|3′ | — |
| 17. F2 × R1 | Ŝ2\|3′ | — | — |
| 18. F3 | Ŝ1\|2′ | — | — |

For the event F0×R0, a probe data packet elicits a new response data packet. Therefore, C3′|1 521 elicits S3|3′ 523, and C4′|2 529 elicits S4|4′ 531, and S3|3′ 523 and S4|4′ 531 are received in the same order.

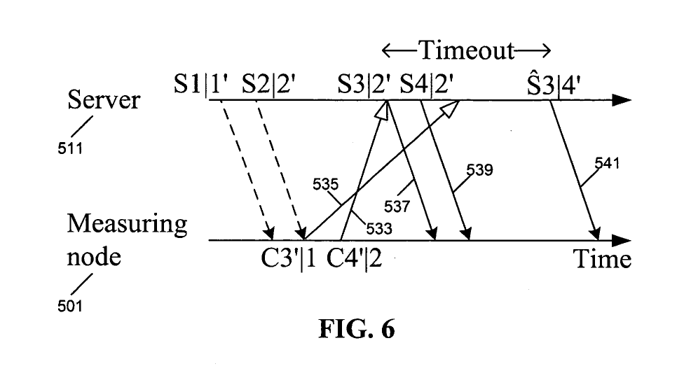

FIG. 6 is a time-line diagram illustrating the server's responses to receiving a reordered probe (the event FR×R0) in accordance with the present invention. The out-of-ordered C4′|2 533 elicits two new response data packets S3|2′ 537 and S4|2′ 539, because C4′|2 533 acknowledges two TCP data segments from the server 511. However, a new probe will not be dispatched, because the two response data packets do not acknowledge the two TCP data segments 3′ and 4′ from the measuring node 501. Consequently, the server timeouts and retransmits the TCP data segment 3 in Ŝ3|4′ 541.

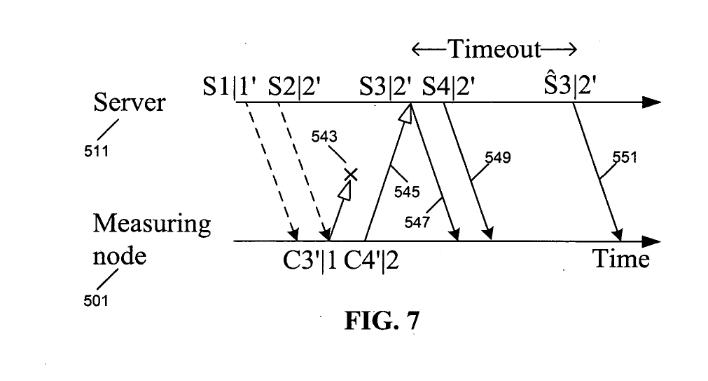

FIG. 7 is a time-line diagram illustrating the server's responses to receiving only the second probe data packet (the event F1×R0) in accordance with the present invention. The first probe data packet is lost 543. Therefore, same as the event FR×R0, the out-of-ordered C4′|2 545 elicits two new response data packets S3|2′ 547 and S4|2′ 549. For the same reason as for the path event FR×R0, the server timeouts and retransmits TCP data segment 3 in Ŝ3|2′ 551. However, this data retransmission packet 551 is distinguishable from the one for the event FR×R0 541, because of their different ANs.

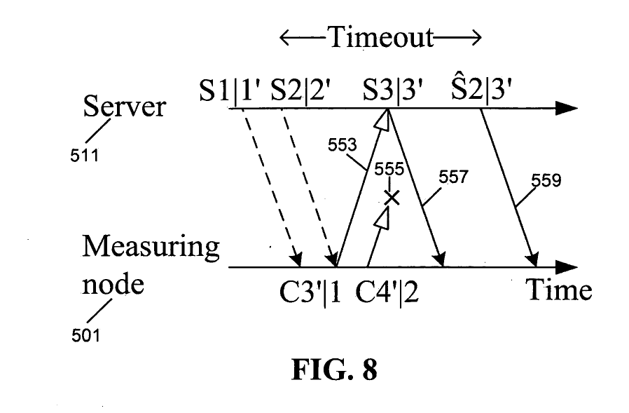

FIG. 8 is a time-line diagram illustrating the server's responses to receiving only the first probe data packet (the event F2×R0) in accordance with the present invention. The first probe data packet C3′|1 553 elicits the response data packet S3|3′ 557, but the second probe data packet C4′|2 is lost 555. For the same reason as for the path event FR×R0, the server timeouts and retransmits TCP data segment 2 in Ŝ2|3′ 559. Unlike the events FR×R0 and F1×R0, where TCP data segment 3 is retransmitted, TCP data segment 2 is retransmitted in this case. Therefore, the data retransmission packets in FR×R0, F1×R0 and F2×R0 are all distinguishable.

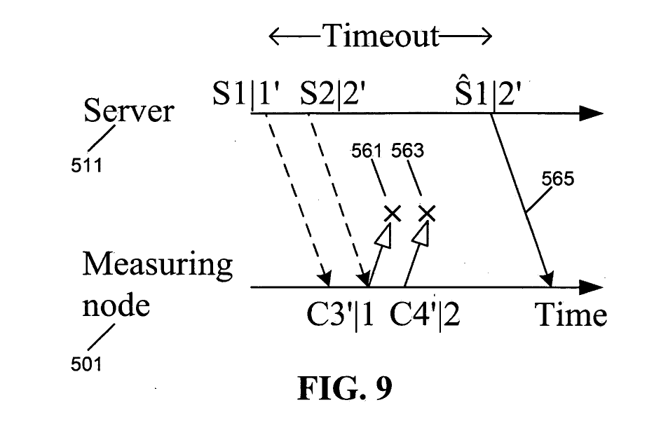

FIG. 9 is a time-line diagram illustrating the server's responses to receiving no probe data packets (the event F3×R0) in accordance with the present invention. Both C3′|1 561 and C4′|2 563 are lost. For the same reason as for the path event FR×R0, the server timeouts and retransmits TCP data segment 1 in Ŝ1|2′ 565. Unlike the events FR×R0, F1×R0 and F2×R0, where TCP data segments 2 and 3 are retransmitted, TCP data segment 1 is retransmitted in this case. Therefore, the data retransmission packets in FR×R0, F1×R0, F2×R0 and F3×R0 are all distinguishable.

A person with ordinary skill in the art can easily construct from FIGS. 5-9 other path events. For example, for the three reverse-path reordering events F0−F1×RR, the two response data packets in FIGS. 5-7 are simply received in a reverse order. For the four events F0−F2×R1, the first response data packets in FIGS. 5-8 are lost. For the three events F0−F1×R2, the second response data packets in FIGS. 5-7 are lost. For the three events F0−F1×R3, both response data packets in FIGS. 5-7 are lost.

The different combinations of the SNs and ANs in the response data packets enable the detection of almost all the 18 path events. By sorting Table 2 according to the response data packets, Table 3 shows that each sequence of the response data packets matches uniquely to a path event, except for the following three cases: A1 (F1×R2 and F1×R3), A2 (F1×RR and F1×R1), and A3 (F0×R3 and FR×R3). For A1, these two events cannot be distinguished based on the response data packets, because S3|2′ and Ŝ3|2′ are identical, and the server may retransmit more than once. For A2, the reasons for their indistinguishability are similar to that for A1. For A3, both events have the same response data packet Ŝ3|4′.

TABLE 3

| First | Second | Third | | |
|---|---|---|---|---|
| response TCP | response TCP | response TCP | Path | |
| data packets | data packets | data packets | events | |
| S3\|2′ | S4\|2′ | Ŝ3\|2′ | 11. | F1 × R0 |
| | | Ŝ3\|4′ | 6. | FR × R0 |
| | Ŝ3\|2′ | — | 14. | F1 × R2 |
| | Ŝ3\|4′ | — | 9. | FR × R2 |
| S3\|3′ | S4\|4′ | — | 1. | F0 × R0 |
| | Ŝ2\|3′ | — | 16. | F2 × R0 |
| | Ŝ3\|4′ | — | 4. | F0 × R2 |
| S4\|2′ | S3\|2′ | Ŝ3\|2′ | 12. | F1 × RR |
| | | Ŝ3\|4′ | 7. | FR × RR |
| | Ŝ3\|2′ | — | 13. | F1 × R1 |
| | Ŝ3\|4′ | — | 8. | FR × R1 |
| S4\|4′ | S3\|3′ | — | 2. | F0 × RR |
| | Ŝ3\|4′ | — | 3. | F0 × R1 |
| Ŝ1\|2′ | — | — | 18. | F3 |
| Ŝ2\|3′ | — | — | 17. | F2 × R1 |
| Ŝ3\|2′ | — | — | 15. | F1 × R3 |
| Ŝ3\|4′ | — | — | 5. | F0 × R3 or |
| | | | 10. | FR × R3 |

The ambiguities in A1 and A2 can be resolved by differentiating between S3|2′ and Ŝ3|2′ by their RTTs. The RTT of Ŝ3|2′ is usually much longer than the RTT of S3|2′. The ambiguity in A3, on the other hand, can be resolved by the TCP timestamps option. Each probe data packet contains a distinct timestamp in the TCP option field. If the server supports the TCP timestamps option, it will retain the timestamp received from the most recent probe data packet that advances its receive window and echo it in its next response data packet. Therefore, the server retains the timestamp of C4′ for the case of F0×R3 and the timestamp of C3′ for the case of FR×R3. The two path events can therefore be distinguished based on the different timestamps in Ŝ3|4′.

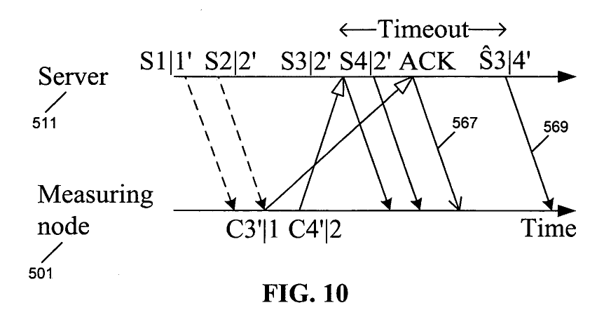

FIG. 10 is a time-line diagram illustrating the server's responses, including a TCP ACK, to receiving a reordered probe in accordance with the present invention. The detection of the forward-path reordering event can be sped up based on receiving a TCP ACK 567 which is usually sent much earlier than the data retransmission packet Ŝ3|4′ 569. The detection of other forward-path reordering events (FR×RR, FR×R1, FR×R2 and FR×R3) can be accelerated in the same way.

For the path events 1-2, a new probe round could be started immediately after receiving two new response data packets. For each of the remaining path events, without relying on TCP ACKs, an old response TCP data packet is retransmitted upon timeout, and the server's congestion window is reset to one TCP data segment. To start a new probe round, the measurement kernel therefore first sends one or more new TCP ACKs to increase the server's congestion window back to two TCP data segments for path events 3-18. After receiving two new response data packets, the measuring node could dispatch a new probe: C5′ and C6′ for events 3-10, C4′ and C5′ for events 16-17, and C3′ and C4′ for event 18. Handling events 11-15 is more involved. If a new probe of C3′ and C4′ were used, the server will drop C4′, because it has already been received. A viable approach is to retransmit C3′ with the respective ANs and to use a new probe of C5′ and C6′ for the next probe round after a successful retransmission of C3′.

The measurement kernel in the receptive mode captures the response data packets (e.g., using libpcap) and filters packets irrelevant to the measurement, such as TCP window updates. By determining the path event based on the sequence of the response data packets in Table 3 and the assistance of TCP ACKs, various statistics for per-packet RTT, forward-path and reverse-path packet loss, and forward-path and reverse-path packet reordering can then be computed. For example, after conducting a number of consecutive probe rounds, say 120, over one minute, an average forward-path (and reverse-path) loss rate can be computed by dividing the number of the first-probe-packet-loss events (and the first-response-packet-loss events) by 120. Average packet reordering rates can be computed in a similar manner.

The measurement results for the successive probe rounds can be processed either online or offline. The online processing is possible, because the measuring node only needs to determine the path event based on the sequence of the response data packets received from the server. The offline processing has the advantages of preventing the processing workload from influencing the probing process and of facilitating a more accurate disambiguation of A1 and A2 based on the RTT samples collected in the measurement.

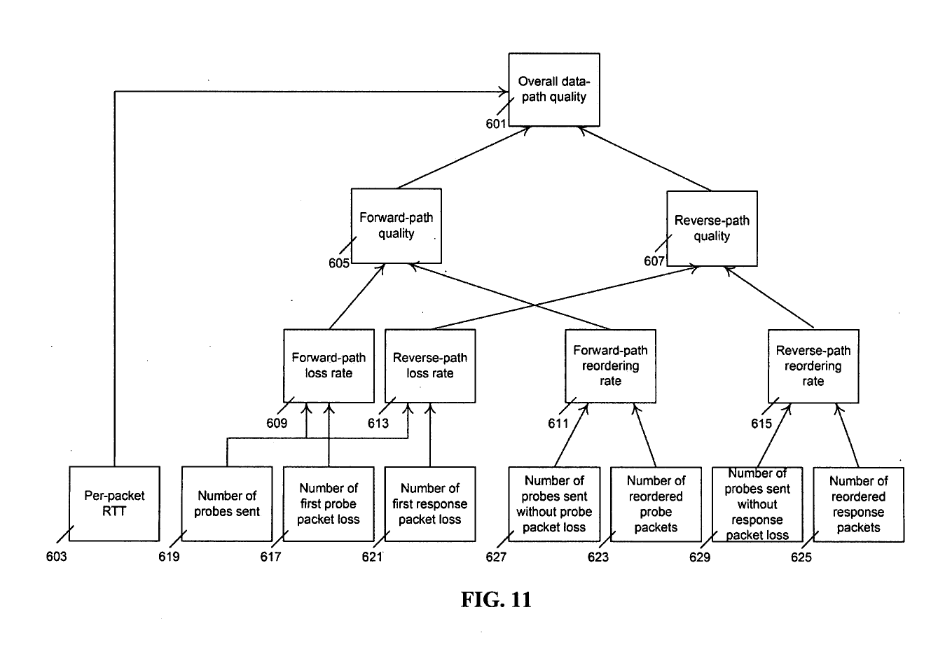

FIG. 11 is a block diagram illustrating a partial set of path metrics supported by the present invention. The overall data-path quality 601 is measured by the per-packet RTT 603, the forward-path quality 605 and the reverse-path quality 607. The forward-path quality 605 is in turn measured by the forward-path loss rate 609 and forward-path packet reordering rate 611. Similarly, the reverse-path quality 607 is in turn measured by the reverse-path loss rate 613 and reverse-path packet reordering rate 615. The forward-path loss rate 609 could be computed by dividing the number of first probe data packet loss 617 by the total number of probes sent 619. Similarly, the reverse-path loss rate 613 could be computed by dividing the number of first response data packet loss 621 by 619. The forward-path packet reordering rates 611 is computed for the probes for which the probe data packets are not lost 627. The forward-path packet reordering rates 611 could be computed by dividing the number of reordered probe data packets 623 by 627. The reverse-path packet reordering rates 615 is computed for the probes for which the response data packets are not lost 629. The reverse-path packet reordering rates 615 could be computed by dividing the number of reordered response data packets 625 by 629.

A self-diagnosis is also included to confirm that the measurement is free of self-induced packet losses. For the forward-path measurement, failures of sending out the probe data packets are still possible, despite that the packet transmissions can be validated by a successful invocation of the sendto( ) function. To detect these self-induced losses, libpcap could be used to verify the delivery of each outgoing probe data packet to the network. For the reverse-path measurement, self-induced packet losses could also occur to the response data packets due to insufficient buffer space. The ps_drop variable returned by the libpcap's pcap_stats( ) function could be used to detect such losses.

Exemplary Probe and Response Data Packets

Table 5 shows, as an example, the structure of the probe and response data packet (including the TCP header and TCP payload, and each row contains a 32-bit word). Other elements belonging to the lower layer of the protocol stack (such as, the IP header, and Ethernet header and trailer) are excluded, because they are not directly related to the exemplary embodiment.

TABLE 5

| | | | | | | | | | | | | | | | | | | | | | | | | | | |
|---|---|---|---|---|---|---|---|---|---|---|---|---|---|---|---|---|---|---|---|---|---|---|---|---|---|---|
| 00 | 1 | 2 3 | 4 | 5 | 6 | 7 | 8 | 9 | 10 | 1 | 2 | 3 | 4 | 5 | 6 | 7 8 | 9 | 20 | 1 2 | 3 4 | 5 | 6 7 | 8 | 9 | 30 | 1 |

| | |
|---|---|
| Source Port | Destination Port |

Sequence Number
Acknowledgment Number

| | | | | | | | | | | |
|---|---|---|---|---|---|---|---|---|---|---|
| Data | Reserved | CWR | ECN | URG | ACK | PSH | RST | SYN | FIN | Window Size |
| Offset | | | | | | | | | | |

| | |
|---|---|
| Checksum | Urgent Pointer |

HTTP Data

The actual content of exemplary probe and response data packets is illustrated in the following examples.

### EXAMPLE 1

### The Path Event F0×R0

Table 6 is the first probe data packet C3′|1 (with a 240-byte TCP data payload):

TABLE 6

| Fields | Value (in decimal) |
|---|---|
| Source Port | 11949 |
| Destination Port | 80 |
| Sequence Number | 1649735825 |
| Acknowledgement | 418938821 |
| Number | |
| Data Offset | 5 |
| Reserved | 0 |
| CWR | 0 |
| ECN | 0 |
| URG | 0 |
| ACK | 1 |
| PSH | 1 |
| RST | 0 |
| SYN | 0 |
| FIN | 0 |
| Window Size | 480 |
| Checksum | 8357 |
| HTTP Data | GET /test1.txt HTTP/1.1\r\nHost: |
| | www.oneprobe.org\r\nUser-Agent: |
| | OneProbe/0.1\r\nAccept: |
| | */*\r\nConnection: keep-alive\r\nReferer: |
| | http://www.oneprobe.org/ |
| | ?s=04094161792100000004000000040One- |
| | Probe0Measurement0OneProbe0Measurement0- |
| | OneProbe0Measurem\r\n\r\n |

Table 7 is the second probe data packet C4′|2 (with a 240-byte TCP data payload):

TABLE 7

| Fields | Value (in decimal) |
|---|---|
| Source Port | 11949 |
| Destination Port | 80 |
| Sequence Number | 1649736065 |
| Acknowledgement | 418939061 |
| Number | |
| Data Offset | 5 |
| Reserved | 0 |
| CWR | 0 |
| ECN | 0 |
| URG | 0 |
| ACK | 1 |
| PSH | 1 |
| RST | 0 |
| SYN | 0 |
| FIN | 0 |
| Window Size | 480 |
| Checksum | 7876 |
| HTTP Data | GET /test2.txt HTTP/1.1\r\nHost: |
| | www.oneprobe.org\r\nUser-Agent: OneProbe/ |
| | 0.1\r\nAccept: */*\r\nConnection: |
| | keep-alive\r\nReferer: http://www.oneprobe.org/ |
| | ?s=04094161792100000004000000040One- |
| | Probe0Measurement0OneProbe0Measurement0One- |
| | Probe0Measurem\r\n\r\n |

Table 8 is the first response data packet S3|3′ (with a 240-byte TCP data payload):

TABLE 8

| Fields | Value (in decimal) |
|---|---|
| Source Port | 80 |
| Destination Port | 11949 |
| Sequence Number | 418939061 |
| Acknowledgement | 1649736065 |
| Number | |
| Data Offset | 5 |
| Reserved | 0 |
| CWR | 0 |
| ECN | 0 |
| URG | 0 |
| ACK | 1 |
| PSH | 1 |
| RST | 0 |
| SYN | 0 |
| FIN | 0 |
| Window Size | 49200 |
| Checksum | 46172 |
| HTTP Data | 01234567890123456789012345678901234567890 |
| | 1234567890123456789012345678901234567890 |
| | 123456789012345678901234567890123456789 |
| | 0123456789012345678901234567890123456789 |
| | 0123456789012345678901234567890123456789 |
| | 0123456789012345678901234567890123456789 |

Table 9 is the second response data packet S4|4′ (with a 240-byte TCP data payload):

TABLE 9

| Fields | Value (in decimal) |
|---|---|
| Source Port | 80 |
| Destination Port | 11949 |
| Sequence Number | 418939301 |
| Acknowledgement | 1649736305 |
| Number | |
| Data Offset | 5 |
| Reserved | 0 |
| CWR | 0 |
| ECN | 0 |
| URG | 0 |
| ACK | 1 |
| PSH | 1 |
| RST | 0 |
| SYN | 0 |
| FIN | 0 |
| Window Size | 49200 |
| Checksum | 59235 |
| HTTP Data | 0123456789012345678901234567890123456789 |
| | 0123456789012345678901234567890123456789 |
| | 0123456789012345678901234567890123456789 |
| | 0123456789012345678901234567890123456789 |
| | 0123456789012345678901234567890123456789 |
| | 0123456789012345678901234567890123456789 |

### EXAMPLE 2

### The Path Event FR×R0

Table 10 is the first probe data packet C3′|1 (with a 240-byte TCP data payload):

TABLE 10

| Fields | Value (in decimal) |
|---|---|
| Source Port | 11949 |
| Destination Port | 80 |
| Sequence Number | 1649735825 |
| Acknowledgement | 418938821 |
| Number | |
| Data Offset | 5 |
| Reserved | 0 |
| CWR | 0 |
| ECN | 0 |
| URG | 0 |
| ACK | 1 |
| PSH | 1 |
| RST | 0 |
| SYN | 0 |
| FIN | 0 |
| Window Size | 480 |
| Checksum | 8357 |
| HTTP Data | GET /test1.txt HTTP/1.1\r\nHost: |
| | www.oneprobe.org\r\nUser-Agent: |
| | OneProbe/0.1\r\nAccept: */*\r\nConnection: |
| | keep-alive\r\nReferer: http://www.oneprobe.org/ |
| | ?s=04094161792100000004000000040One- |
| | Probe0Measurement0OneProbe0Measurement0- |
| | OneProbe0Measurem\r\n\r\n |

Table 11 is the second probe data packet C4′|2 (with a 240-byte TCP data payload):

TABLE 11

| Fields | Value (in decimal) |
|---|---|
| Source Port | 11949 |
| Destination Port | 80 |
| Sequence Number | 1649736065 |
| Acknowledgement | 418939061 |
| Number | |
| Data Offset | 5 |
| Reserved | 0 |
| CWR | 0 |
| ECN | 0 |
| URG | 0 |
| ACK | 1 |
| PSH | 1 |
| RST | 0 |
| SYN | 0 |
| FIN | 0 |
| Window Size | 480 |
| Checksum | 7876 |
| HTTP Data | GET /test2.txt HTTP/1.1\r\nHost: |
| | www.oneprobe.org\r\nUser-Agent: |
| | OneProbe/0.1\r\nAccept: */*\r\nConnection: |
| | keep-alive\r\nReferer: http://www.oneprobe.org/ |
| | ?s=04094161792100000004000000040One- |
| | Probe0Measurement0OneProbe0Measurement0- |
| | OneProbe0Measurem\r\n\r\n |

Table 12 is the first response data packet S3|2′ (with a 240-byte TCP data payload):

TABLE 12

| Fields | Value (in decimal) |
|---|---|
| Source Port | 80 |
| Destination Port | 11949 |
| Sequence Number | 418939061 |
| Acknowledgement | 1649735825 |
| Number | |
| Data Offset | 5 |
| Reserved | 0 |
| CWR | 0 |
| ECN | 0 |
| URG | 0 |
| ACK | 1 |
| PSH | 1 |
| RST | 0 |
| SYN | 0 |
| FIN | 0 |
| Window Size | 49200 |
| Checksum | 9451 |
| HTTP Data | 0123456789012345678901234567890123456789 |
| | 0123456789012345678901234567890123456789 |
| | 0123456789012345678901234567890123456789 |
| | 0123456789012345678901234567890123456789 |
| | 0123456789012345678901234567890123456789 |
| | 0123456789012345678901234567890123456789 |

Table 13 is the second response data packet S4|2′ (with a 240-byte TCP data payload):

TABLE 13

| Fields | Value (in decimal) |
|---|---|
| Source Port | 80 |
| Destination Port | 11949 |
| Sequence Number | 418939301 |
| Acknowledgement | 1649735825 |
| Number | |
| Data Offset | 5 |
| Reserved | 0 |
| CWR | 0 |
| ECN | 0 |
| URG | 0 |
| ACK | 1 |
| PSH | 1 |
| RST | 0 |
| SYN | 0 |
| FIN | 0 |
| Window Size | 49200 |
| Checksum | 6472 |
| HTTP Data | 0123456789012345678901234567890123456789 |
| | 0123456789012345678901234567890123456789 |
| | 0123456789012345678901234567890123456789 |
| | 0123456789012345678901234567890123456789 |
| | 0123456789012345678901234567890123456789 |
| | 0123456789012345678901234567890123456789 |

Table 14 is the third response data packet Ŝ3|4′ (with a 240-byte TCP data payload):

TABLE 14

| Fields | Value (in decimal) |
|---|---|
| Source Port | 80 |
| Destination Port | 11949 |
| Sequence Number | 418939061 |
| Acknowledgement | 1649736305 |
| Number | |
| Data Offset | 5 |
| Reserved | 0 |
| CWR | 0 |
| ECN | 0 |
| URG | 0 |
| ACK | 1 |
| PSH | 0 |
| RST | 0 |
| SYN | 0 |
| FIN | 0 |
| Window Size | 49200 |
| Checksum | 51436 |
| HTTP Data | 0123456789012345678901234567890123456789 |
| | 0123456789012345678901234567890123456789 |
| | 0123456789012345678901234567890123456789 |
| | 0123456789012345678901234567890123456789 |
| | 0123456789012345678901234567890123456789 |
| | 0123456789012345678901234567890123456789 |

Validation of the Response TCP Data Packets

A small suite of validation tests is devised to validate the correctness of the response data packets returned by an operating system or web server. Table 4 describes the four validation tests V0-V2 that “simulate” the forward-path events F0-F2, respectively. The testing probes are sent out with an advertised receive window set to two TCP data segments, and the response data packets are not acknowledged in order to simulate reverse-path packet losses. The data retransmissions are therefore expected to be the same as in Table 2. Moreover, the tests for reverse-path packet losses have already covered the test for F3, because withholding the next probe is the same as losing it.

TABLE 4

| | | Expected packets | Expected data |
|---|---|---|---|
| Tests | Testing probes | elicited from server | retransmissions |
| V0. | {C3′\|1, C4′\|2} | {S3\|3′, S4\|4′} | Ŝ3\|4′ |
| VR. | {C4′\|2, C3′\|1} | {S3\|2′, S4\|2′} | Ŝ3\|4′ |
| V1. | C4′\|2 only | {S3\|2′, S4\|2′} | Ŝ3\|2′ |
| V2. | C3′\|1 only | S3\|3′ | Ŝ2\|3′ |

The validation tests were successful for all the operating systems and web servers tested in a laboratory and the Internet: FreeBSD v4.5/4.11/5.5/6.0/6.2, Linux kernel v2.4.20/2.6.5/2.6.11/2.6.15/2.6.18/2.6.20, MacOSX 10.4 server, NetBSD 3.1, OpenBSD 4.1, Solaris 10.1, Windows 2000/XP/Vista, AIX, AS/400, BSD/OS, Compaq Tru64, F5 Big-IP, HP-UX, IRIX, MacOS, NetApp NetCache, NetWare, OpenVMS, OS/2, SCO Unix, Solaris 8/9, SunOS 4, VM, Microsoft Windows NT4/98/Server 2003/2008, Abyss, Apache, Lighttpd, Microsoft IIS, Nginx, AOLserver, Araneida, Apache Tomcat, GFE, GWS-GRFE, IBM HTTP Server, Jetty, Jigsaw, LiteSpeed, Lotus-Domino, Mongrel, Netscape-Enterprise, OmniSecure, Oracle HTTP Server, Orion, Red Hat Secure, Redfoot, Roxen, Slinger, Stronghold, Sun Java System, thttpd, Twisted Web, Virtuoso, WebLogic, WebSiphon, Yaws, Zeus and Zope.

### Other Embodiments

Another exemplary embodiment uses three or more probe TCP data packets in a single probe which will trigger more than two new response TCP data packets for path measurement. This embodiment has the advantage of covering more loss-reordering scenarios than the first embodiment. However, its disadvantage is that the probe transmissions are more complex to manage, and the analysis of the response packets is also more difficult.

Another exemplary embodiment is performing the measurement from a web server (instead of a web client). This embodiment is useful for monitoring the data-path quality of a large number of web clients.

Another exemplary embodiment uses the Stream Control Transfer Protocol (SCTP), instead of TCP, for path measurement. Since SCTP supports multiple, concurrent TCP-like flows, the SCTP contains all the necessary protocol elements for practicing the present invention.

Another exemplary embodiment uses other TCP-based application protocols, such as FTP and P2P, or SCTP-based applications for the application module.

Exemplary Computing Environment

The method for the present invention is operational with numerous other general-purpose or special-purpose computing system environments or configurations. Examples of well known computing systems, environments, and/or configurations that may be suitable for practicing the present invention include, but are not limited to, personal computers, server computers, thin clients, thick clients, hand-held or laptop devices, multiprocessor systems, microprocessor-based systems, set top boxes, programmable consumer electronics, wireless phone, wireless communication devices, network PCs, minicomputers, mainframe computers, distributed computing environments that include any of the above systems or devices, and the like.

The measuring node according to the present invention may be described in the general context of computer-executable instructions, such as program modules, being executed by a computer. Generally, program modules include routines, programs, objects, components, data structures, etc. that perform particular tasks or implement particular abstract data types. The measuring node according to the present invention may also be practiced in distributed computing environments where tasks are performed by remote processing devices that are linked through a communications network. In a distributed computing environment, program modules may be located in both local and remote computer storage media including memory storage devices.

While there have been described and pointed out fundamental novel features of the invention as applied to a preferred embodiment thereof, it will be understood that various omissions and substitutions and changes, in the form and details of the embodiments illustrated, may be made by those skilled in the art without departing from the spirit of the invention. The invention is not limited by the embodiments described above which are presented as examples only but can be modified in various ways within the scope of protection defined by the appended patent claims.

What is claim is:

1. A method for non-cooperatively measuring data-path quality of a communications network, comprising:
(a) sending from a measuring node a probe designed to elicit a response from a remote node, said probe comprising at least two data packets with a content being application messages, and said response from said remote node containing at least one data packet which contains at least one application message or a portion of an application message;
(b) receiving and processing said data packet in said response which are capable of providing at least three types of data-path quality metrics; and
(c) obtaining a measurement or assessment about data-path quality between said measuring node and said remote node from said data-path quality processed in step (b).

2. The method of claim 1, further comprises repeating steps (a) and (b) a plurality of times prior to performing step (c).

3. The method of claim 2, wherein said three types of path quality metrics are round-trip time, packet loss rate and packet reordering rate.

4. The method of claim 3, wherein said packet loss rate comprises independently forwarding packet loss rate and returning packet loss rate.

5. The method of claim 3, wherein said packet reordering rate comprises independently forwarding packet reordering rate and returning packet reordering rate.

6. The method of claim 1, wherein said communications network is using TCP for communication and said data packets of both said probe and said response are TCP data packets.

7. The method of claim 6, wherein said remote node is a web server, said application messages from said measuring node are HTTP GET messages and said application messages from said web server are HTTP response messages.

8. The method of claim 7, wherein said probe is sent in step (a) with a predetermined probe packet size, predetermined sampling rate and predetermined sampling pattern specified by a user.

9. The method of claim 7, wherein said response is received in step (b) with a predetermined response packet size specified by a user.

10. An apparatus for performing the method of claim 1 and capable of sending a probe to a remote node, and receiving and processing a response from said remote node, comprising:
(a) a user input terminal,
(b) a probe preparation module, and
(c) a measurement kernel;
wherein said user input terminal is used to specify information about the identity of a remote node, packet sizes for said probe and said response, and probe sampling rate and sampling pattern; said probe preparation module configures said probe with said information from said user input terminal about identity of said remote node and packet sizes for said probe and said response; said measurement kernel is responsible for sending said probe to said remote node at a probe sampling rate and sampling pattern based on said information specified from said user input terminal, and for processing said response from said remote node to derive therefrom a set of data-path quality metrics.

11. The apparatus of claim 10, which is a general-purpose computer connected to a communications network under measurement, wherein said user input terminal, probe preparation module and measurement kernel are built at least partially through software implementation.

12. The apparatus of claim 10, wherein said probe preparation module is an HTTP module for using a web server for data-path quality measurement and said HTTP module is capable of finding one or more qualified http URLs for a user-specified packet size and preparing an HTTP GET message for each of said qualified http URLs.

13. The apparatus of claim 12, wherein said HTTP GET message must induce a 200 (OK) response from said remote node.

14. The apparatus of claim 12, wherein said HTTP GET message does not induce a 404 (Not Found) response nor a 304 (Not Modified) response from said remote node.

15. The apparatus of claim 10, wherein said measurement kernel operates independent of the type of the TCP application on which said probe preparation module is based.

16. The apparatus of claim 10, wherein said measurement kernel operates with a single TCP connection or with two or more concurrent TCP connections.

17. The method of claim 1, wherein said data packet of said response comprises a sequence number and an acknowledgement number.

18. The method of claim 17, wherein the size of said data packet of said response is pre-determinable by a user.
